(19) United States
(12) Patent Application Publication
(10) Pub. No.: US 2025/0035937 A1
(43) Pub. Date: Jan. 30, 2025

(54) PROJECTION SUBSTRATE AND METHOD FOR MANUFACTURING PROJECTION SUBSTRATE

(71) Applicant: Cellid, Inc., Tokyo (JP)

(72) Inventors: Tatsuo INABATA, Tokyo (JP); Toshiaki SHOZU, Tokyo (JP); Susumu TATEOKA, Tokyo (JP); Satoshi SHIRAGA, Tokyo (JP)

(73) Assignee: Cellid, Inc., Tokyo (JP)

(21) Appl. No.: 18/917,999

(22) Filed: Oct. 16, 2024

Related U.S. Application Data
(63) Continuation of application No. PCT/JP2022/018028, filed on Apr. 18, 2022.

(51) Int. Cl. G02B 27/01

(52) U.S. Cl. CPC G02B 27/0172; G02B 2027/0178

(57) ABSTRACT

This projection substrate is for causing an image to be projected onto a second surface on the opposite side of a first surface while causing at least a portion of light of a specific wavelength range incident on the first surface to be transmitted through the second surface, the projection substrate having a transparent glass plate that is provided on the first surface side, and a diffraction grating that is provided on the second surface side with respect to the glass plate and that has a plurality of grooves formed with a resist so that light corresponding to the image propagates while being diffracted, wherein the thickness of a resist film between the bottom surface of the grooves and the glass plate is determined on the basis of the wavelength of light diffracted in the grooves.

### CROSS-REFERENCE TO RELATED APPLICATIONS

The present application is a continuation application of International Application number PCT/JP2022/018028, filed on Apr. 18, 2022. The contents of this application are incorporated herein by reference in their entirety.

### BACKGROUND OF THE INVENTION

The present disclosure relates to a projection substrate for projecting an image, and a method for manufacturing the projection substrate.

In head mounted display devices, light that is outputted from an optical projector system propagates through a waveguide formed on a transparent substrate and is visible to a user (for example, Japanese Unexamined Patent Application Publication (Translation of PCT Application) No. 2021-509726).

There is a demand for increasing a viewing angle in head-mounted display devices, which refers to an angular extent of an observable image. A display device described in Japanese Unexamined Patent Application Publication (Translation of PCT Application) No. 2021-509726 has a problem that increasing the viewing angle causes luminance non-uniformity.

### BRIEF SUMMARY OF THE INVENTION

The present disclosure focuses on this point, and an object thereof is to provide a projection substrate capable of suppressing luminance non-uniformity in a head mounted display device.

A projection substrate of a first embodiment of the present disclosure is a projection substrate for projecting an image onto a second surface that is opposite to a first surface, while transmitting at least a portion of light in a specific wavelength range incident from the first surface to the second surface, including a transparent glass plate that is provided on the first surface, and a diffraction grating that i) is provided between the first surface and the second surface, positioned closer to the second surface than the glass plate and ii) has a plurality of grooves formed by a resist so that the light corresponding to the image propagates while being diffracted, wherein a thickness of a resist film between a bottom surface of the grooves and the glass plate is determined on the basis of a wavelength of the light diffracted in the grooves.

A method for manufacturing a projection substrate of a second embodiment of the present disclosure is a method for manufacturing a projection substrate for projecting an image, including the steps of applying a resist on a transparent glass plate, pressing a mold formed with a plurality of grooves against the resist to a position determined on the basis of a wavelength of light diffracted in the plurality of grooves, curing the resist by ultraviolet rays or heat while the mold is pressed against the resist, and removing the mold from the resist.

### BRIEF DESCRIPTION OF THE DRAWINGS

FIG. 1 shows a configuration example of an eyewear-type terminal according to the present embodiment.

FIG. 2 schematically shows an optical path of projection light in the eyewear-type terminal according to the present embodiment.

FIG. 3 schematically shows the optical path of the projection light in a projection substrate according to the present embodiment.

FIG. 4 shows an example of i) the projection light radiated by a projection part according to the present embodiment to the projection substrate and ii) image light emitted from the projection substrate.

FIG. 5 shows a configuration example of the projection substrate according to the present embodiment.

FIG. 6 shows a configuration example of an incident region 210 including a diffraction grating.

FIG. 7 shows a configuration example of the incident region 210 including a multi-step type diffraction grating.

FIG. 8 shows a configuration example of the incident region 210 including a slanted-type diffraction grating.

FIG. 9 shows a configuration example of the incident region 210 including a blazed-type diffraction grating.

FIG. 10 illustrates a thickness of a resist film.

FIGS. 11A and 11B show results of simulating luminance of an image formed on a pupil.

FIGS. 12A and 12B show results of simulating luminance of the image formed on the pupil.

FIGS. 13A to 13C show another example of results of simulating luminance of the image formed on the pupil.

FIG. 14 shows a modification of the eyewear-type terminal according to the present embodiment.

FIGS. 15A to 15C show a method for manufacturing a projection substrate.

FIGS. 16A to 16C show the method for manufacturing the projection substrate.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Configuration Examples of Eyewear-Type Terminal 10

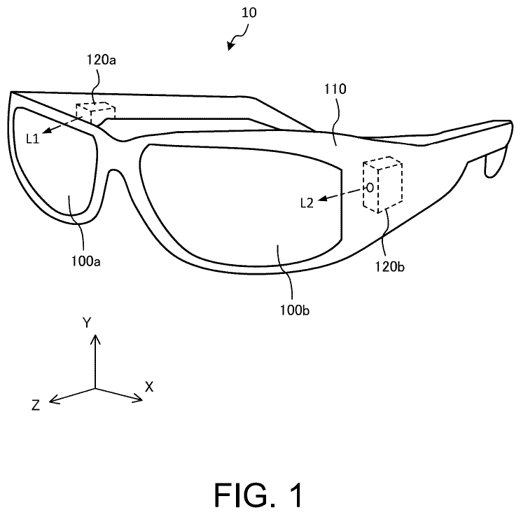

FIG. 1 shows a configuration example of an eyewear-type terminal 10 according to the present embodiment. In the present embodiment, three axes orthogonal to each other are defined as an X-axis, a Y-axis, and a Z-axis. The eyewear-type terminal 10 is a wearable device worn by a user, for example. The eyewear-type terminal 10 projects image light corresponding to an image onto a display region provided in a projection substrate 100 while allowing the user to observe a scene through eyewear. The eyewear-type terminal 10 includes the projection substrate 100, a frame 110, and a projection part 120.

The projection substrate 100 projects an image onto its second surface while transmitting at least a portion of light in a specific wavelength range incident from its first surface to the second surface. Here, the first surface of the projection substrate 100 is a surface that faces away from the user when the user is wearing the eyewear-type terminal 10. Further, the second surface of the projection substrate 100 faces the user when the user is wearing the eyewear-type terminal 10. FIG. 1 shows an example in which the first surface and the second surface of the projection substrate 100 are arranged substantially parallel to the XY plane. The projection substrate 100 is a substrate in which a diffraction grating functioning as a waveguide is formed on a glass plate, for example. A glass plate 112 is provided on the first surface of the projection substrate. The diffraction grating is provided between the first surface and the second surface, positioned closer to the second surface than the glass plate 112. A plurality of grooves are formed in the diffraction grating by a resist. The grooves are formed so that light corresponding to an image propagates while being diffracted. The projection substrate 100 will be described later.

A frame 110 secures the projection substrate 100. The frame 110 is provided with the projection substrate 100 as at least one of a lens for the user's right eye or a lens for the user's left eye. FIG. 1 shows an example in which a projection substrate 100a is provided as the lens for the user's right eye, and a projection substrate 100b is provided as the lens for the user's left eye on the frame 110.

Alternatively, a single projection substrate 100 may be provided as the lens for the user's right eye or the lens for the user's left eye on the frame 110. In addition, a single projection substrate 100 may be provided as a lens for the user's both eyes on the frame 110. In this case, the frame 110 may have a goggle shape. The frame 110 includes components such as temples and straps, allowing the user to wear the eyewear-type terminal 10.

The projection part 120 is provided in the frame 110, and irradiates the projection substrate 100 with projection light for projecting image light onto the projection substrate 100. One or more such projection parts 120 are provided in the frame 110. FIG. 1 shows an example in which the frame 110 is provided with i) a projection part 120a for irradiating the projection substrate 100a with projection light L1 and ii) a projection part 120b for irradiating the projection substrate 100b with projection light L2.

The projection part 120 may be provided at a portion of the frame 110 where the projection substrate 100 is secured, or may be provided at a temple or the like of the frame 110. It is preferable that the projection part 120 is provided integrally with the frame 110. For example, the projection part 120 irradiates the projection substrate 100 with projection light including a single wavelength to allow the user to observe a monochromatic image. In addition, the projection part 120 may cause the user to observe an image including a plurality of colors by irradiating the projection substrate 100 with projection light including a plurality of wavelengths.

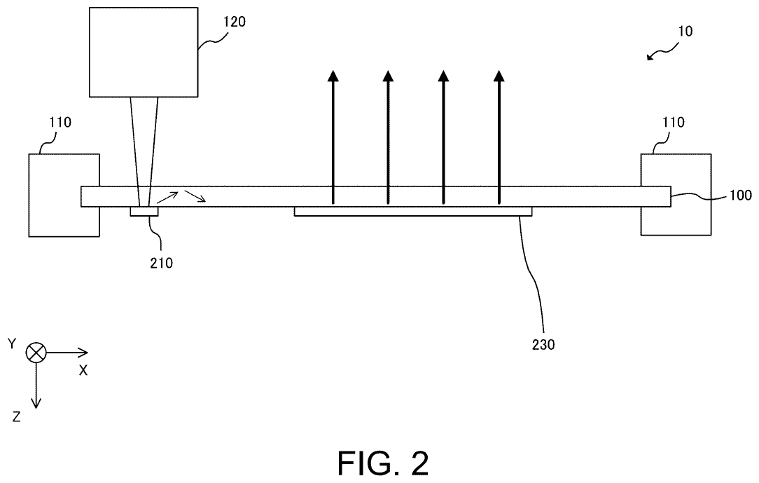

FIG. 2 schematically shows an optical path of the projection light in the eyewear-type terminal 10 according to the present embodiment. The projection part 120 irradiates the incident region 210 provided to the projection substrate 100 with the projection light. The incident region 210 guides the projection light into the projection substrate 100. The projection substrate 100 then emits the projection light guided within the substrate as image light from an emission region 230. The incident region 210 and the emission region 230 will be described later.

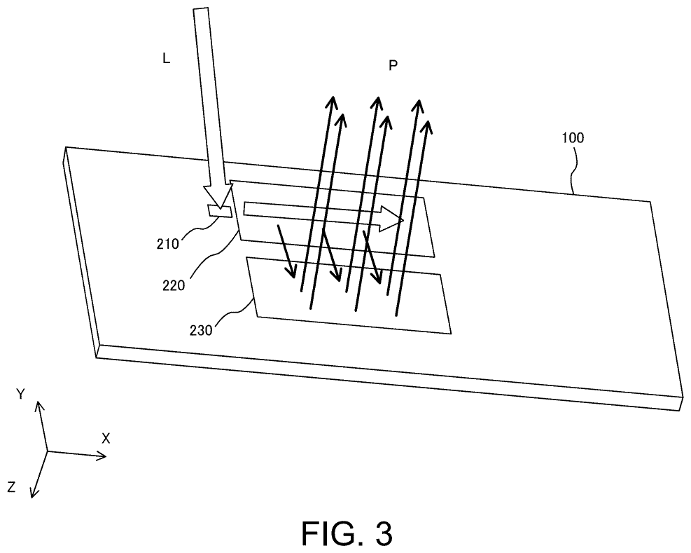

FIG. 3 schematically shows an optical path of the projection light in the projection substrate 100 according to the present embodiment. As will be described later, the projection substrate 100 includes the incident region 210, a branching region 220, and the emission region 230. The projection light L is incident on the incident region 210, passes through the branching region 220, and exits from the emission region 230 as image light P. The branching region 220 guides portions of the projection light L to the emission region 230 incrementally as the projection light L propagates away from the incident region 210.

Similarly, the emission region 230 emits portions of the projection light L as portions of the image light P incrementally as the projection light L propagates away from the branching region 220. Thus, the projection substrate 100 emits the projection light L incident on the incident region 210 as the image light P from the emission region 230.

Here, considered a case where the branching region 220 guides the projection light L to the emission region 230 at a constant ratio throughout the entire area of the branching region 220. In this case, an amount of the projection light L decreases as the projection light L propagates away from the incident region 210. Therefore, the intensity of the projection light L entering the emission region 230 from the branching region 220 may be different depending on a distance from the incident region 210.

Similarly, considered a case where the emission region 230 emits the projection light L as the image light P at a constant ratio throughout the entire area of the emission region 230. In this case, the amount of the projection light L decreases as the projection light L propagates away from the branching region 220. Therefore, the intensity of the image light P emitted from the emission region 230 may be different depending on the distance from the incident region 210 and the distance from the emission region 230. For example, luminance may gradually decrease from the upper-left pixel to the lower-right pixel of the image projected by the emission region 230. The projection substrate 100 according to the present embodiment reduces such luminance non-uniformity.

### Example of Projection Light and Image Light

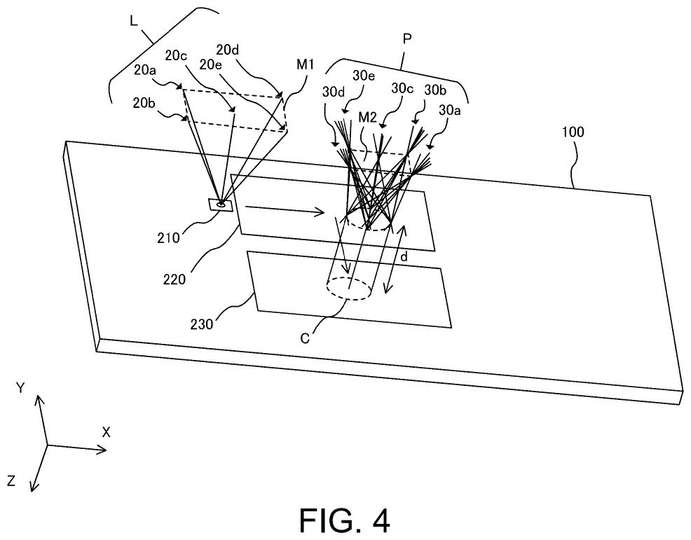

FIG. 4 shows an example of i) the projection light L radiated by the projection part 120 according to the present embodiment to the projection substrate 100 and ii) the image light P emitted from the projection substrate 100. The projection part 120 radiates the projection light L toward the second surface of the projection substrate 100 located in the +Z direction, for example. The projection light L corresponds to an image to be shown to the user, and for example, when the projection light L is projected onto a screen or the like installed on a surface substantially parallel to the XY plane and, an image M1 to be observed by the user is displayed on that screen. The image to be shown to the user is an Augmented Reality (AR) image or a Virtual Reality (VR) image created by a processor included in the projection part 120, for example. In this manner, the projection part 120 irradiates a plane substantially parallel to the XY plane with a plurality of light beams forming the image M1 as the projection light L.

In the present embodiment, an example in which the projection part 120 projects the image M1, having a rectangular shape whose longitudinal direction in the X-axis direction, onto the plane substantially parallel to the XY plane will be described. Further, in FIG. 4, five of the plurality of light beams radiated by the projection part 120 are shown as input light beams 20. For example, a light beam corresponding to the upper-left pixel of the image is a first input light beam 20a, a light beam corresponding to the lower-left pixel of the image is a second input light beam 20b, a light beam corresponding to a central pixel of the image is a third input light beam 20c, a light beam corresponding to the upper-right pixel of the image is a fourth input light beam 20d, and a light beam corresponding to the lower-right pixel of the image is a fifth input light beam 20e.

The projection unit 120 irradiates the incident region 210 of the projection substrate 100 with such projection light L, for example, to form an erect virtual image at infinity or a predetermined position. The projection light incident on the incident region 210 is emitted as the image light P from the emission region 230 through the branching region 220. The image light P is emitted from the emission region 230 and enters the user's eye at a distance d from the projection substrate 100. The image light P then forms an image M2 on the retina of the user's eye. Thus, the image light P includes a plurality of light beam flux that form the image M2.

In FIG. 4, five of a plurality of light beam flux, radiated from a circular region C of the emission region 230 of the projection substrate 100 and forms an image at a predetermined position, are shown as output light beam flux 30. For example, a light beam flux forming an image as the lower-right pixel of the image is a first output light beam flux 30a, a light beam flux forming an image as the upper-right pixel of the image is a second output light beam flux 30b, a light beam flux forming an image as the central pixel of the image is a third output light beam flux 30c, a light beam flux forming an image as the lower-left pixel of the image is a fourth output light beam flux 30d, and a light beam flux forming an image as the upper-left pixel of the image is a fifth output light beam flux 30e.

Each light beam flux corresponds to each of the plurality of input light beams 20 incident from the projection part 120. For example, the first output light beam flux 30a i) corresponds to the first input light beam 20a, and ii) includes a plurality of light beams generated by a plurality of times of branching, diffraction, and the like as the first input light beam 20a propagates from the incident region 210 to the emission region 230 of the projection substrate 100. Similarly, the second output light beam flux 30b corresponds to the second input light beam 20b, the third output light beam flux 30c corresponds to the third input light beam 20c, the fourth output light beam flux 30d corresponds to the fourth input light beam 20d, and the fifth output light beam flux 30e corresponds to the fifth input light beam 20e.

In other words, the image M2 formed by the image light P emitted from the emission region 230 on the retina of the user's eye corresponds to the image M1 projected by the projection part 120 using the projection light L. As a result, the user wearing the eyewear-type terminal 10 can perceive that the image M2 as if it is projected onto the second surface of the projection substrate 100, superimposed over the scene viewed through the projection substrate 100. In other words, the emission region 230 functions as a display region for displaying the image M2 corresponding to the image M1 projected by using the projection light L.

FIG. 4 illustrates an example in which the image M2 observed by the user is an image obtained by inverting the image M1, projected by using the projection light L, in the vertical and horizontal directions. It should be noted that the image M1 projected by using the projection light L may be a still image or a moving image instead of the still image. Next, the projection substrate 100 that emits the image light P corresponding to the incident projection light L will be described.

### Configuration Example of Projection Substrate 100

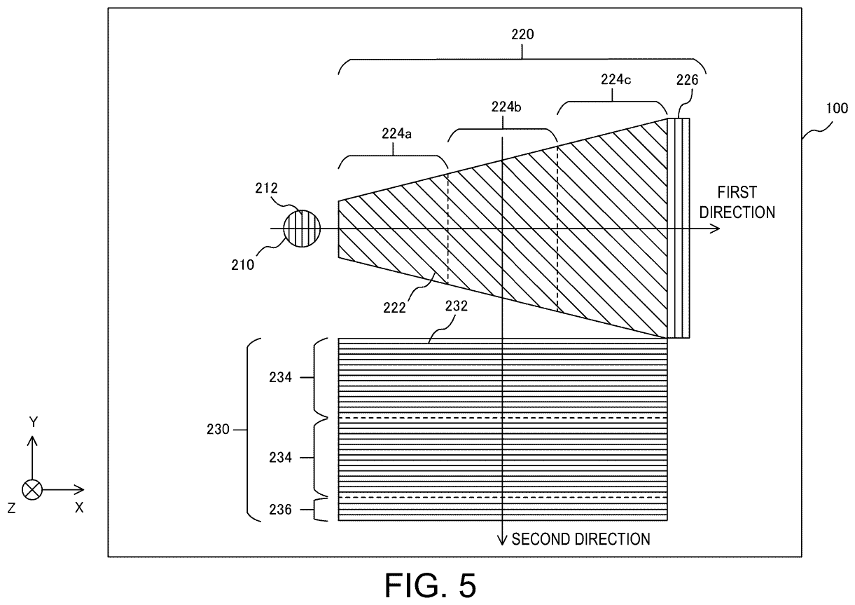

FIG. 5 shows a configuration example of the projection substrate 100 according to the present embodiment. FIG. 5 shows an example in which the first surface and the second surface of the projection substrate 100 are arranged substantially parallel to the XY plane. The projection substrate 100 is a substrate for projecting the image light onto the second surface while transmitting at least a portion of the light incident from the first surface to the second surface that is opposite to the first surface. The projection substrate 100 is a glass plate, for example. The projection substrate 100 includes the incident region 210, the branching region 220, and the emission region 230.

### Example of Incident Region 210

The incident region 210 receives the projection light for projecting the image light, and guides the incident projection light toward the branching region 220. FIG. 5 illustrates an example in which the incident region 210 has a circular shape in the plane substantially parallel to the XY plane, but the present disclosure is not limited thereto. The incident region 210 only needs to be able to guide the projection light to the branching region 220, and may have a shape such as an elliptical, polygonal, or trapezoidal form.

The incident region 210 has a diffraction grating with a plurality of first grooves 212 formed at a first period. In other words, the plurality of first grooves 212 function as a diffraction grating by being arranged in the same direction on a top surface of the projection substrate 100 at predetermined groove widths and intervals. The incident region 210 includes a reflection-type or transmission-type diffraction grating. The diffraction grating (corresponding to a first diffraction grating) of the incident region 210 transmits or reflects the projection light incident from the first surface in a predetermined direction. For example, the diffraction grating of the incident region 210 guides the projection light toward the branching region 220 by reflection-type diffraction or transmission-type diffraction.

The first period of the plurality of first grooves 212 is in the range of about 10 nm to about 10 μm, for example. The first period is preferably in the range of about 100 nm to about 1 μm. The first period is more preferably in the range of about 200 nm to about 800 nm. The depth of the plurality of first grooves 212 ranges from about 1 nm to about 10 μm. The depth of the plurality of first grooves 212 is preferably in the range of about 50 nm to about 800 nm.

The fill factor of the plurality of first grooves 212 is preferably in the range of 0.05 or more and 0.95 or less. Here, the fill factor is a value obtained by dividing a distance between two adjacent first grooves 212 by the first period. It should be noted that the distance between two adjacent first grooves 212 may be referred to as a line, the width of the first groove 212 may be referred to as a space, and the first period may be referred to as a pitch, where the pitch is the sum of the line and the space, and the fill factor is a value obtained by dividing the line by the pitch.

The plurality of first grooves 212 are arranged in a direction from the incident region 210 toward the branching region 220, for example. Here, the propagating direction of the projection light from the incident region 210 toward the branching region 220 is defined as a first direction. FIG. 5 shows an example in which the first direction is a direction substantially parallel to the X-axis direction, and the first grooves 212 extending in a direction substantially parallel to the Y-axis direction are arranged in the first direction. Since the projection light is incident on the incident region 210 while converging, the incident region 210 guides the projection light to the branching region 220 so as to have a spread angle around the first direction within the plane of the projection substrate 100.

### Example of Branching Region 220

The branching region 220 guides a portion of the projection light incident from the incident region 210 toward the emission region 230. The branching region 220 is provided in a region through which the projection light passes in the plane substantially parallel to the XY plane. The branching region 220 has a reflection-type diffraction grating. The diffraction grating (corresponding to a second diffraction grating) of the branching region 220 diffracts a portion of the projection light incident from the diffraction grating of the incident region 210. The diffraction grating of the branching region 220 guides the projection light toward the emission region 230 by reflection-type diffraction. The branching region 220 has a rectangular shape whose longitudinal direction is in the first direction, for example.

It should be noted that since the projection light propagates while spreading out, centered on the first direction, the branching region 220 preferably has a shape that expands outward from a center axis of the projection light extending along the first direction, which is the direction of propagation of the projection light through the incident region 210, as the branching region 220 extends farther from the incident region 210. The branching region 220 has a trapezoidal shape, a fan shape, or the like on the plane substantially parallel to the XY plane, for example. FIG. 5 shows an example in which the branching region 220 has a trapezoidal shape. Such a shape of the branching region 220 can be formed corresponding to the region where the projection light propagates while spreading in the XY plane, enabling efficient guiding of the projection light.

The branching region 220 has a diffraction grating with a plurality of second grooves 222 formed at a second period. In other words, the plurality of second grooves 222 are arranged in the same direction on the top surface of the projection substrate 100 at predetermined groove widths and intervals.

The second period of the plurality of second grooves 222 is different from the first period of the plurality of first grooves 212. The second period is preferably selected to be an appropriate period for guiding the projection light to the emission region 230. The second period is in a range of about 10 nm to about 10 μm, for example. The second period is preferably in the range of about 50 nm to about 1 μm. The second period is more preferably in the range of about 100 nm to about 700 nm. The depth of the plurality of second grooves 222 ranges from about 1 nm to about 10 μm. The depth of the plurality of second grooves 222 is preferably in the range of about 5 nm to about 800 nm.

The plurality of second grooves 222 are, for example, arranged in a predetermined direction. For instance, a direction from the branching region 220 to the emission region 230 is defined as a second direction, and an angle formed by the first direction and the second direction is defined as a first angle. In this case, the plurality of second grooves 222 are formed to be inclined in the second direction at an angle that is half of the first angle, relative to the first direction. FIG. 5 shows an example in which the second direction is substantially parallel to the Y-axis direction, the first angle is substantially 90 degrees, and the plurality of second grooves 222 are arranged to be inclined in the second direction at substantially 45 degrees, relative to the first direction.

The branching region 220 includes a plurality of first divided regions 224 arranged in the propagating direction of the incident projection light. The depths of the second grooves 222 formed in the plurality of first divided regions 224 are different from each other. In other words, in the branching region 220, the second grooves 222 are formed so that the ratio of the inputted projection light that is guided to the emission region 230 is different for each first divided region 224.

The branching region 220 preferably has three or more first divided regions 224. The second periods of the plurality of second grooves 222 formed in the plurality of first divided regions 224 are all the same, for example. As described above, by dividing the branching region 220 into the plurality of first divided regions 224 and making the amount of projection light guided to the emission region 230 different for each first divided region 224, the branching region 220 adjusts the distribution of the amount of light in the direction perpendicular to the propagation direction of the projection light to remain approximately uniform while guiding the projection light, the intensity of which differs depending on the distance from the incident region 210, to the emission region 230.

For example, the second grooves 222 provided in one first divided region 224 are formed so that the depth of the second grooves 222 in the one first divided region 224 is greater than the depth of the second grooves 222 in a first divided region 224 that is closer to the incident region 210. In this case, the rate of change in the depth of the second grooves 222 between two adjacent first divided regions 224 among the plurality of first divided regions 224 may increase as the distance from the incident region 210 increases.

As an example, considered a case where the branching region 220 has three first divided regions 224 as shown in FIG. 5. The diffraction grating of the branching region is disposed in i) a first divided region 224a, ii) a first divided region 224b positioned at a greater distance from the diffraction grating of the incident region 210 compared to the first divided region 224a, and iii) a first divided region 224c positioned at a greater distance from the diffraction grating of the incident region 210 compared to the first divided region 224b. Here, it is assumed that the depth of the second grooves 222a are formed in the first divided region 224a, which is the closest to the incident region 210 among the three first divided regions 224, so as to guide approximately ¼ of the amount of the incident projection light to the emission region 230. In this case, the remaining approximately 3/4 of the amount of the incident projection light incident on the first divided region 224a, which is the closest to the incident region 210, is incident on the adjacent first divided region 224b.

It is assumed that the depth of the second grooves 222b are formed in the first divided region 224b so as to guide approximately ⅓ of the amount of the incident projection light to the emission region 230. In other words, the second grooves 222b of the first divided region 224b, which is the second closest to the incident region 210, are formed with a depth greater than the depth of the second grooves 222a in the first divided region 224a, which is the closest to the incident region 210, so as to guide 4/3 times the amount of light to the emission region 230 compared to the amount of light guided by the first divided region 224a. Such a first divided region 224b will guide approximately ¼ of the amount of the projection light incident on the first divided region 224a, which is the closest to the incident region 210, to the emission region 230.

Then, the remaining approximately ½ of the amount of the projection light incident on the first divided region 224a, which is the closest to the incident region 210, is incident on the adjacent first divided region 224c. It is assumed that the depth of the second grooves 222c are formed in the first divided region 224c, which is the third closest to the incident region 210, so as to guide approximately ½ of the amount of the incident projection light to the emission region 230. In other words, the second grooves 222c of the first divided region 224c, which is the third closest to the incident region 210, are formed with a depth greater than the depth of the second grooves 222b so as to guide 3/2 times the amount of light to the emission region 230 compared to the first divided region 224b, which is the second closest to the incident region 210.

In addition, the change rate of the depth of the second grooves 222 between two adjacent first divided regions 224 among the three first divided regions 224 is formed to increase as the distance from the incident region 210 increases. Then, the first divided region 224c, which is the third closest to the incident region 210, will guide approximately ¼ of the amount of the projection light incident on the first divided region 224a, which is the closest to the incident region 210, to the emission region 230. As in the above examples, in the branching region 220, different amounts of the projection light are guided to the emission region 230 for each of the plurality of first divided regions 224. This allows the projection light to be guided to the emission region 230 while maintaining a nearly constant distribution of the amount of light guided to the emission regions 230 corresponding to each of the first divided regions 224.

It should be noted that the branching region 220 may further include a first reflection region 226, which is one of the first divided regions 224, at a position farthest from the incident region 210. FIG. 5 shows an example in which the branching region 220 has three first divided regions 224 and the first reflection region 226. The first reflection region 226 reflects at least a portion of the light, having passed through the plurality of first divided regions 224, to the plurality of first divided regions 224. The first reflection region 226 includes the second grooves 222 having a depth greater than the depths of the second grooves 222 of the adjacent first divided region 224.

For example, it is preferable that the depth of the second grooves 222 of the first reflection region 226 is substantially three times or more the greatest depth of the second grooves 222 of the plurality of first divided regions 224. It is more preferable that the depth of the second grooves 222 of the first reflection region 226 is substantially ten times or more the greatest depth of the second grooves 222 of the plurality of first divided regions 224. It should be noted that the second grooves 222 of the first reflection region 226 may be arranged in the first direction.

The branching region 220 has such a first reflection region 226, and so the plurality of first divided regions 224 guide at least a portion of the light reflected by the first reflection region 226 to the emission region 230. Thus, the branching region 220 can guide greater amount of projection light to the emission region 230. It should be noted that the depth of the second grooves 222 of each of the plurality of first divided regions 224 may be determined so that the amount of projection light, including the light reflected by the first reflection region 226, guided to the emission region 230 by each of the first divided regions 224 maintains substantially uniform.

### Examples of Cross-Sectional View of Incident Region 210

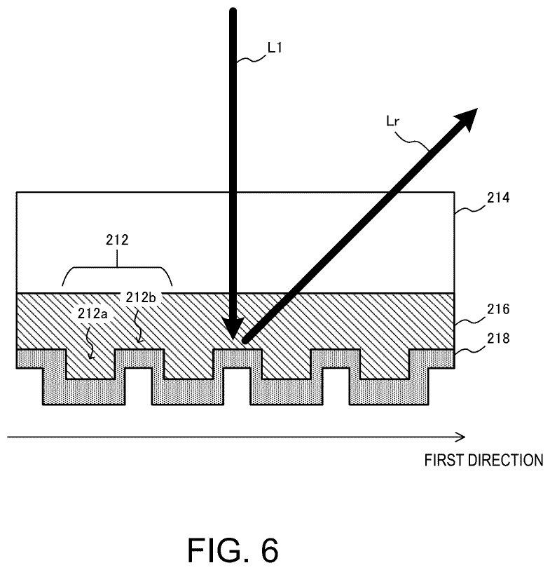

FIG. 6 shows a configuration example of the incident region 210 including a diffraction grating. The incident region 210 includes a transparent substrate 214, a resin layer 216, and a reflection layer 218. The transparent substrate 214 is formed of a material through which the projection light L1 passes. The transparent substrate 214 is made of glass or plastic, for example. The transparent substrate 214 according to the present embodiment is formed of glass having a thickness of 0.4 mm. It should be noted that an anti-reflection coating may be provided on a surface of the transparent substrate 214 opposite to a surface facing the resin layer 216. The anti-reflection coating is formed of magnesium fluoride, sapphire, or silicon dioxide, for example. This reduces reflection on the surface of the transparent substrate 214 opposite to the surface facing the resin layer 216.

The resin layer 216 is formed of a resin or a resist, for example. The thickness of the resin layer 216 is 10 nm or more and less than 500 nm, for example. The thickness of the resin layer 216 is preferably 30 nm or more and less than 200 nm.

The resin layer 216 includes a plurality of first grooves 212 which are concave-convex portions. The plurality of first grooves 212 are repeatedly formed at a first period in a direction that guides the projection light L1 to the branching region 220. As shown in FIG. 6, the first grooves 212 form a binary-type diffraction grating including a concave portion 212a and a convex portion 212b. In other words, the plurality of first grooves 212 function as a diffraction grating by being arranged in the same direction on the top surface of the projection substrate 100 at predetermined groove widths and intervals. The diffraction grating of the incident region 210 is a reflection-type diffraction grating. The diffraction grating of the incident region 210 guides projection light Lr toward the branching region 220 by reflection-type diffraction.

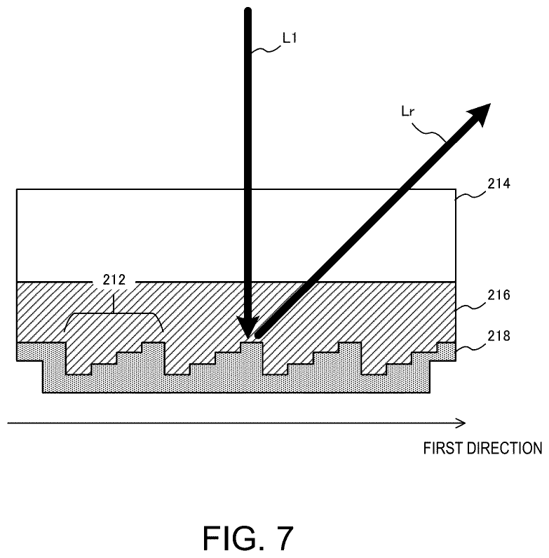

The plurality of first grooves 212 may be formed in a stepwise shape. In other words, the first grooves 212, formed in a stepwise shape, form a multi-step type diffraction grating. FIG. 7 shows a configuration example of the incident region 210 including a multi-step type diffraction grating.

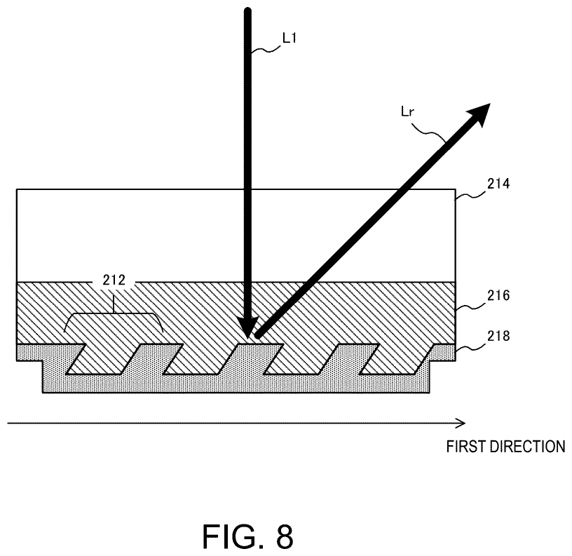

The plurality of first grooves 212 may be formed to be inclined in a direction that guides the projection light L1 to the branching region 220. In other words, the first grooves 212 configured to be inclined in the direction that guides the projection light L1 to the branching region 220 form a slanted-type diffraction grating (also referred to as a stent-type diffraction grating). FIG. 8 shows a configuration example of the incident region 210 including a slanted-type diffraction grating.

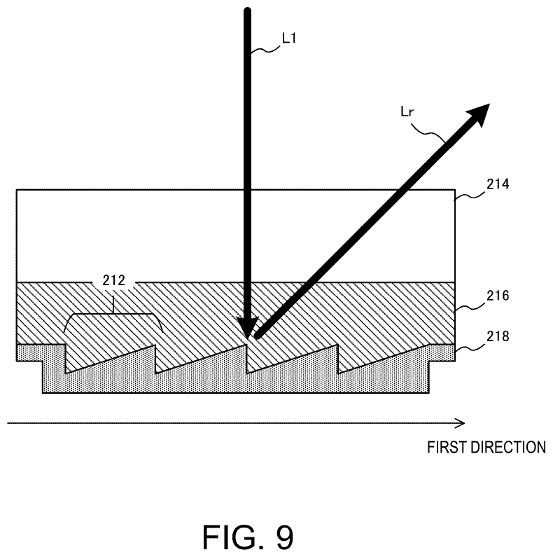

The plurality of first grooves 212 may be formed in a saw blade shape. In other words, the first grooves 212, which have a saw blade shape, form a blazed-type diffraction grating (also referred to as a ruled diffraction grating). FIG. 9 shows a configuration example of the incident region 210 including the blazed-type diffraction grating.

The reflection layer 218 reflects the projection light L1 transmitted through the transparent substrate 214 and the resin layer 216. The reflection layer 218 is formed on a surface opposite to a surface facing the transparent substrate 214 in the diffraction grating, which is composed of the plurality of first grooves 212. The reflection layer 218 is formed of a metal, for example. Specifically, the reflection layer 218 is formed of at least any one of aluminum, silver, tantalum oxide, or nickel oxide. The reflection layer 218 is formed of aluminum having a thickness of about 10 nm to about 200 nm, for example. The reflection layer 218 is preferably formed to have a thickness ranging from about 50 nm to about 150 nm. The reflection layer 218 of the present embodiment is formed of aluminum having a thickness of 100 nm.

The reflection layer 218 is formed so as to cover the surface of the resin layer 216 opposite to the surface facing the transparent substrate 214. For example, the reflection layer 218 is formed so that the thickness of the reflection layer 218 is uniform like the binary-type diffraction grating shown in FIG. 6. In addition, the transparent substrate 214 may be formed so that the surface of the reflection layer 218 is flat as shown in FIG. 7.

### Examples of Thickness of Resist Film

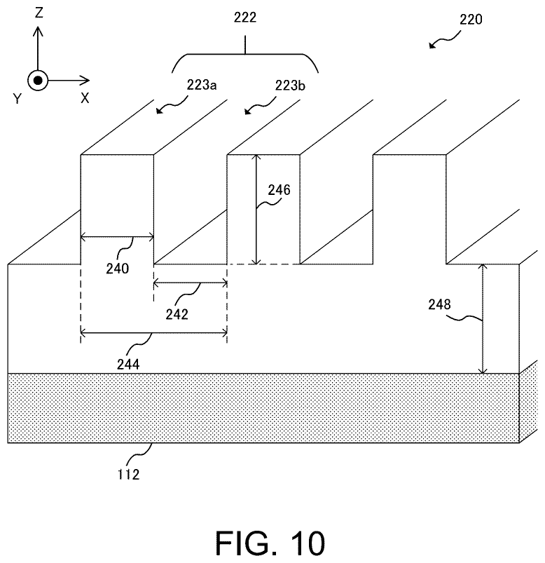

FIG. 10 illustrates the thickness of a resist film. The plurality of second grooves 222 are formed on the glass plate 112. A line 240 is the width of a convex portion 223a of the second grooves 222. A space 242 is the width of a first concave portion 223b of the second groove 222. A pitch 244 is the sum of the line 240 and the space 242, and is the length of the second period. The first fill factor is the line 240 divided by the pitch 244.

A thickness 248 of the resist film between the bottom surface of the second grooves 222 and the glass plate 112 is 10 nanometers or more and less than 500 nanometers, for example. The thickness 248 of the resist film is determined by the wavelength of light diffracted in the second grooves 222. More specifically, the thickness 248 of the resist film for diffracting green light (wavelength: 490 nanometers to 550 nanometers) is determined to be greater than the thickness 248 of the resist film for diffracting blue light (wavelength: 430 nanometers to 490 nanometers).

The thickness 248 of the resist film between the bottom surface of the second grooves 222 and the glass plate 112 is determined on the basis of a depth 246 of the second grooves 222 and the pitch 244 of the second grooves 222. In the example herein, the thickness 248 of the resist film, when the pitch is 260 nanometers, is 30 nanometers or more and less than 200 nanometers. In this case, the thickness 248 of the resist film is preferably 20 times or less the depth 246 of the second grooves 222.

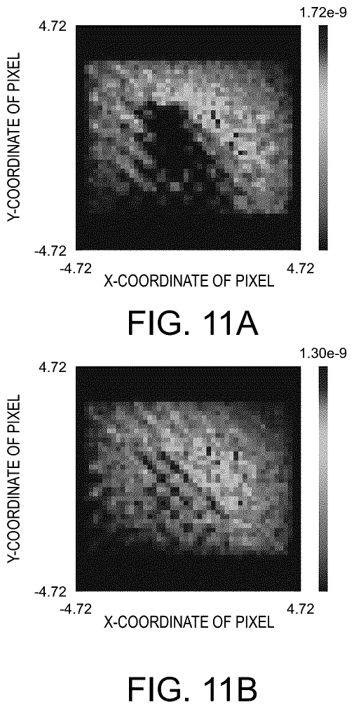

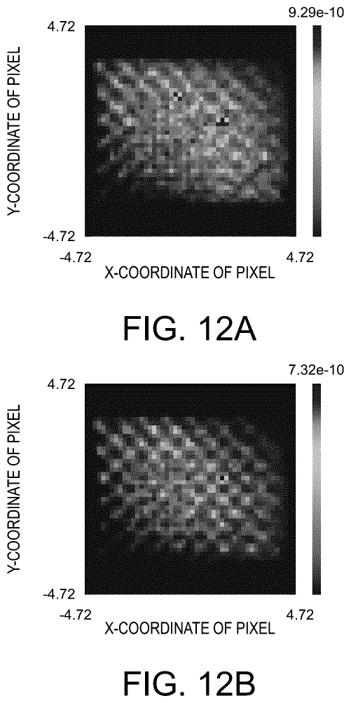

FIGS. 11 and 12 show results of simulating luminance of an image formed on a pupil. In FIG. 11, the vertical axis and the horizontal axis respectively represent the X-coordinate and the Y-coordinate of the pixel. FIGS. 11 and 12 show results of simulating the luminance of the image under a plurality of conditions in which the thickness 248 of the resist film between the bottom surface of the grooves and the glass plate 112 in the incident region 210 is different. The luminance of the image is also simulated in the branching region 220 and the emission region 230 under the same conditions, and the same results are obtained.

FIG. 11A shows a simulation result of the luminance of the image when the thickness 248 of the resist film is 50 nanometers. FIG. 11B shows a simulation result of the luminance of the image when the thickness 248 of the resist film is 100 nanometers. FIG. 12A shows a simulation result of the luminance of the image when the thickness 248 of the resist film is 150 nanometers. FIG. 12B shows a simulation result of the luminance of the image when the thickness 248 of the resist film is 200 nanometers. A black area in the diagram indicates an area of luminance non-uniformity.

When the thickness 248 of the resist film is increased from 50 nanometers (FIG. 11A) to 100 nanometers (FIG. 11B), the black area showing luminance non-uniformity generated in the center of FIG. 11A is reduced. When the thickness 248 of the resist film is increased from 100 nanometers (FIG. 11B) to 150 nanometers (FIG. 12A), the black area showing luminance non-uniformity generated in the center of FIG. 11B is further reduced. On the other hand, when the thickness 248 of the resist film is increased from 150 nanometers (FIG. 12A) to 200 nanometers (FIG. 12B), the overall luminance of the image decreases. The simulation results of FIGS. 11 and 12 show that, when a value of the thickness 248 of the resist film on the projection substrate 100 is within an appropriate range, luminance non-uniformity can be suppressed in a state where the viewing angle of the eyewear-type terminal 10 is relatively large.

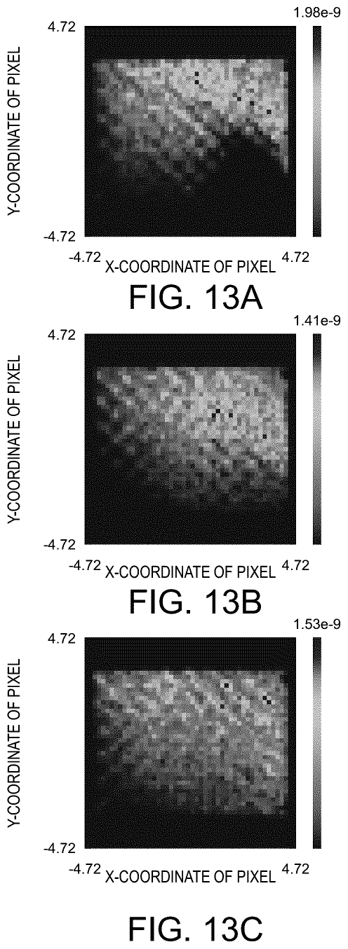

FIG. 13 shows another example of results of simulating luminance of the image formed on the pupil. In FIG. 13, the vertical axis and the horizontal axis represent the X-coordinate and the Y-coordinate of the pixel. FIG. 13 shows results of simulating luminance of the image under a plurality of conditions in which the thickness 248 of the resist film between the bottom surface of the grooves and the glass plate 112 in the incident region 210 is different. The luminance of the image is simulated under the same conditions in the branching region 220 and the emission region 230, and the same results are obtained.

FIG. 13A is a simulation result of the luminance of the image when the thickness 248 of the resist film is 100 nanometers. FIG. 13B is a simulation result of the luminance of the image when the thickness 248 of the resist film is 150 nanometers. FIG. 13C is a simulation result of the luminance of the image when the thickness 248 of the resist film is 200 nanometers.

A darker portion in FIG. 13 indicates that the luminance is low. When the thickness 248 of the resist film is increased from 100 nanometers shown in FIG. 13A to 150 nanometers (FIG. 13B), a black area indicating luminance non-uniformity generated in the lower-right portion of FIG. 13A is reduced. When the thickness 248 of the resist film is increased from 150 nanometers shown in FIG. 13B to 200 nanometers (FIG. 13C), a black area showing luminance non-uniformity generated in the lower right and lower left portion of FIG. 13B is further reduced. The simulation results of FIG. 13 show that the greater the thickness 248 of the resist film, i) the smaller the luminance non-uniformity of the entire image and ii) the more uniform the luminance. On the other hand, when the thickness 248 of the resist film is excessively large, the overall luminance may decrease or luminance non-uniformity may occur. Therefore, in the projection substrate 100, by setting the thickness 248 of the resist film to a value within the appropriate range, it is possible to suppress luminance non-uniformity in a state where the viewing angle of the eyewear-type terminal 10 is relatively large.

In addition, the smaller the difference between the refractive index of the resist and the refractive index of the glass plate, the more easily the luminance non-uniformity is suppressed. For example, the difference between the refractive index of the resist and the refractive index of the glass plate is preferably 0.4 or less. In one example, the refractive index of the glass plate is 2.1. The refractive index of the resist is 1.9.

### Example of Emission Region 230

The emission region 230 of FIG. 5 guides at least a portion of the projection light incident from the branching region 220 and emits the light as the image light from the second surface of the projection substrate 100. FIG. 5 shows an example in which the emission region 230 has a rectangular shape whose longitudinal direction is in the X-axis direction on the plane substantially parallel to the XY plane, but the present disclosure is not limited thereto. The emission region 230 may have a shape such as a rectangle, a square, or a trapezoid whose longitudinal direction is in the Y-axis direction, as long as the projection light can be guided and emitted as image light.

The emission region 230 has a diffraction grating with a plurality of third grooves 232 formed at a third period. In other words, the plurality of third grooves 232 function as a diffraction grating by being arranged in the same direction on the top surface of the projection substrate 100 at predetermined groove widths and intervals. The emission region 230 has a reflection-type or transmission-type diffraction grating. The diffraction grating (corresponding to the third diffraction grating) of the emission region 230 reflects or transmits at least a portion of the light incident from the diffraction grating of the branching region 220. The diffraction grating of the emission region 230 projects the reflected or transmitted light as the image light. The diffraction grating of the emission region 230 guides the image light in a direction toward the user's eye by the reflection diffraction or transmission diffraction.

The third period of the plurality of third grooves 232 provided in the emission region 230 is different from the second period of the plurality of second grooves 222 of the branching region 220. The third period of the plurality of third grooves 232 of the emission region 230 may be the same as the first period of the plurality of first grooves 212 of the incidence region 210. In this manner, by matching the period of the diffraction grating provided in a) the region where the projection light is incident and b) the region where the image light is emitted, distortion and other anomalies occurring in the image observed by the user can be reduced.

The third period is formed in a range of about 10 nm to about 10 μm, for example. The third period is preferably formed in a range of about 100 nm to about 1 μm. The third period is more preferably formed in a range of about 200 nm to about 800 nm. The depth of the plurality of third grooves 232 is formed in a range of about 1 nm to about 10 μm. The depth of the plurality of third grooves 232 is preferably formed in a range of about 5 nm to about 800 nm.

The plurality of third grooves 232 are arranged in the second direction from the branching region 220 toward the emission region 230, for example. FIG. 5 shows an example in which the third grooves 232 extending in the first direction are arranged in the second direction.

Similarly to the branching region 220, the emission region 230 includes a plurality of second divided regions 234 arranged in the propagating direction of the projection light incident from the branching region 220. The third grooves 232 formed in the plurality of second divided regions 234 have different depths. In other words, the third grooves 232 are formed in such a manner that the ratio of the inputted projection light emitted as the image light from the emission region 230 is different for each second divided region 234. The emission region 230 preferably includes two or more second divided regions 234. For example, the third grooves 232 provided in one second divided region 234 are formed with a depth greater than the depth of the third grooves 232 provided in a second divided region 234 that is closer to the branching region 220 than the one second divided region 234. In addition, if the emission region 230 includes three or more second divided regions 234, the rate of change of the depth of the third grooves 232 of two adjacent second divided regions 234 may be increased as the distance from the branching region 220 increases. It should be noted that each third periods of the plurality of third grooves 232 are all the same, for example.

As described above, the emission region 230 is divided into a plurality of second divided regions 234, and the amount of light emitted as the image light is made different for each of the second divided regions 234. As a result, the emission region 230, like the plurality of first divided regions 224 in the branching region 220, can guide the projection light as the image light while adjusting the distribution of the amount of light in the entire image to be substantially uniform when an observer views the image light as an image.

The emission region 230 may further include a second reflection region 236, which is one of the second divided regions 234, at a position farthest from the branching region 220. FIG. 5 shows an example where the emission region 230 includes the two second divided regions 234 and the second reflection region 236. The second reflection region 236 reflects at least a portion of the light having passed through the plurality of second divided regions 234 to the plurality of second divided regions 234. The second reflection region 236 has third grooves 232 having a depth greater than the depth of the third grooves 232 of the adjacent second divided region 234.

For example, it is desirable that the depth of the third grooves 232 of the second reflection region 236 is substantially three times or more the greatest depth of the third grooves 232 of the plurality of second divided regions 234. It is more preferable that the depth of the third grooves 232 of the second reflection region 236 is substantially ten times or more the largest depth of the third grooves 232 of the plurality of second divided regions 234.

The emission region 230 has such a second reflection region 236, and so the plurality of second divided regions 234 emit at least a portion of the light reflected by the second reflection region 236 as the image light from the second surface of the projection substrate 100. This enables the emission region 230, like the branching region 220, to emit greater amount of projection light as the image light. It should be noted that the depth of the third grooves 232 of each of the plurality of second divided regions 234 may be determined so that the amount of light emitted as the image light from each of the second divided regions 234, including light reflected by the second reflection region 236, is substantially uniform.

As described above, the projection substrate 100 according to the present embodiment emits the projection light incident on the incident region 210 as the image light from the emission region 230 while branching the projection light at different ratios for each of the plurality of first divided regions 224 of the branching region 220. Accordingly, the projection substrate 100 can reduce luminance non-uniformity of the projection image to be observed by the user. In addition, the projection substrate 100 can further reduce luminance non-uniformity of the image by emitting the image light at different ratios for each of the plurality of second divided regions 234 in the emission region 230.

Such a projection substrate 100 can be realized by forming diffraction gratings corresponding to the incident region 210, the branching region 220, and the emission region 230 on a first surface or a second surface of a glass plate or the like. It should be noted that the grooves forming the diffraction grating is a resist, a resin, or the like, for example. Therefore, the projection substrate 100 according to the present embodiment is a substrate that can be easily produced by forming grooves having a predetermined period and depth for each region without incorporating a complicated optical system.

The widths of the convex portion and the concave portion of each of the plurality of second divided regions 234 are formed so that the second fill factor becomes a predetermined value. The second fill factor is a ratio of the width of the convex portion in the second direction relative to the third period of the third grooves 232. The second fill factor is 0.05 or more and 0.95 or less, for example.

### Another Example of Eyewear-Type Terminal 10

An example of the eyewear-type terminal 10 with the projection substrate 100 provided on the frame 110 and the projection part 120 irradiates the incident region 210 of the projection substrate 100 with the projection light has been described above, but the present disclosure is not limited thereto. For example, a plurality of projection substrates 100 may be fixed to the frame 110 of the eyewear-type terminal 10. Next, such an eyewear-type terminal 10 will be described.

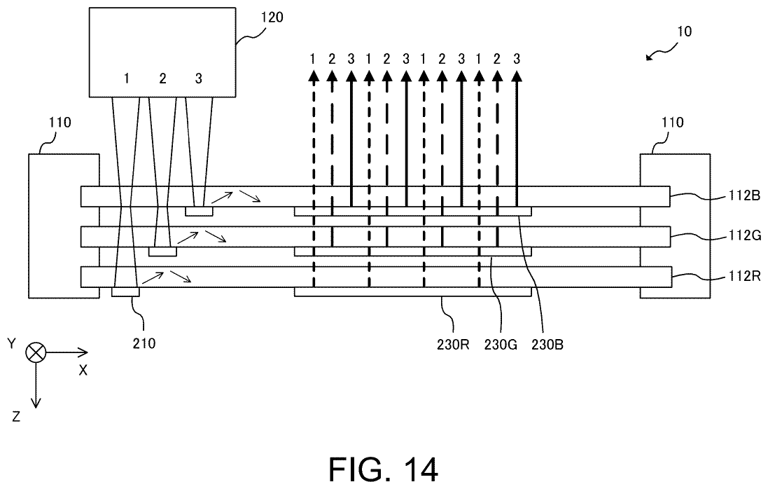

FIG. 14 shows a modification of the eyewear-type terminal 10 according to the present embodiment. In the eyewear-type terminal 10 of the modification, the substantially same operation as that of the eyewear-type terminal 10 according to the present embodiment shown in FIG. 1 is denoted by the same number, and the description thereof is omitted. The appearance of the eyewear-type terminal 10 of the modification may be an appearance that is hardly different from the appearance of the eyewear-type terminal 10 shown in FIG. 1.

A plurality of glass plates 112 are fixed to the frame 110 of the eyewear-type terminal 10 according to the modification. In this case, the plurality of glass plates 112 are fixed to the frame 110 so that, in a plan view substantially parallel to the XY plane, the emission regions 230 provided to each of the plurality of glass plates 112 at least partially overlap. FIG. 14 shows an example where three glass plates 112R, 112G, and 112B are fixed to the frame 110 of the eyewear-type terminal 10, and three emission regions 230R, 230G, and 230B of the projection substrate 100 overlap each other in a plan view parallel to the XY plane.

Diffraction gratings for diffracting light in different wavelength ranges are respectively formed on the plurality of glass plates 112R, 112G, and 112B. The projection part 120 irradiates the incident region 210 provided in each of the plurality of glass plates 112 with projection lights having different wavelengths. The emission regions 230 provided in each of the plurality of glass plates 112 emit image lights corresponding to projection lights, emitted from the projection part 120 to each of the plurality of incidence regions 210, to the user's eye from the second surfaces of the plurality of projection substrates 100.

A user wearing such an eyewear-type terminal 10 observes an image where the image lights of different wavelengths are superimposed, allowing the user to observe an image with mixed colors. FIG. 14 illustrates an example where the projection part 120 radiates each of three projection lights corresponding to a first wavelength range, a second wavelength range, and a third wavelength range that form an image on the incident regions 210 of the three projection substrates 100. The first wavelength range corresponds to red light (580 nanometers to 700 nanometers), for example. The second wavelength range corresponds to green light (480 nanometers to 580 nanometers), for example. The third wavelength range corresponds to blue light (400 nanometers to 480 nanometers), for example. The three projection substrates 100 superimpose a plurality of image lights corresponding to a plurality of colors and emit the superimposed image light to the user's eye. This allows the user to observe an image having a plurality of colors, for example.

As described above, by setting the thickness of the resist film between the bottom surface of the grooves of the diffraction grating and the glass plate to a value within an appropriate range, it is possible to suppress luminance non-uniformity. In the example of FIG. 14, the thicknesses of the resist films corresponding to the plurality of glass plates 112 are determined on the basis of the wavelengths of the lights diffracted by the diffraction grating formed on each glass plate 112. For example, the thickness of the resist film of the diffraction grating that diffracts light corresponding to the first wavelength range is determined to be greater than the thickness of the resist film of the diffraction grating that diffracts light corresponding to the second wavelength range. The thickness of the resist film when the light corresponding to the second wavelength range is diffracted is determined to be greater than the thickness of the resist film when the light corresponding to the third wavelength range is diffracted.

### [Method for Manufacturing Projection Substrate 100]

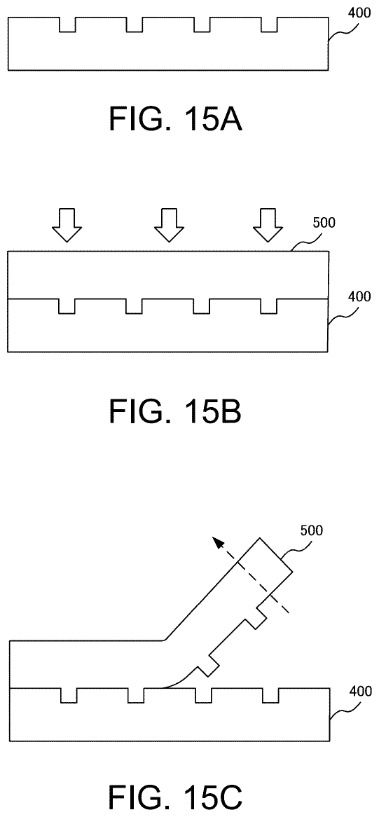

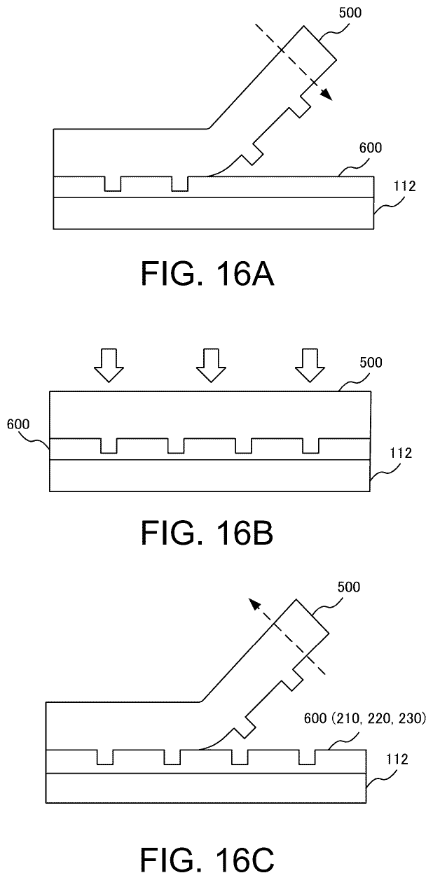

A method for manufacturing the projection substrate 100 of the present embodiment will be described. FIGS. 15A to 15C and FIGS. 16A to 16C illustrate a method for manufacturing the projection substrate 100. FIG. 15A shows an original 400 for manufacturing a mold of the projection substrate 100. FIG. 15B shows a curing of the mold of the projection substrate 100. FIG. 15C shows a removal of the mold of the projection substrate 100 from the original 400.

FIG. 15A shows a cross section of the original 400 for manufacturing the mold of the projection substrate 100. In FIG. 15A, a concave portion formed in the cross section of the original 400 indicates grooves. A stamp material 500 is applied to the original 400. As shown in FIG. 15B, the stamp material 500 applied to the original 400 is cured. The cured stamp material 500 has some elasticity and can be used as a mold for manufacturing the projection substrate 100. As shown by a dashed arrow in FIG. 15C, the mold formed of the cured stamp material 500 is removed from the original 400. A plurality of grooves are formed in the mold.

FIG. 16A shows the stamp material 500 being pressed against a resist 600. FIG. 16B shows a curing of the resist 600. FIG. 16C shows a removal of the stamp material 500 from the resist 600 after curing. Before the step of FIG. 16A, the resist 600 is applied to the transparent glass plate 112. As indicated by the dashed arrow in FIG. 16A, the mold of the stamp material 500 is pressed against the resist 600 to a predetermined position. The predetermined position is determined on the basis of, for example, the wavelength of light diffracted by the plurality of grooves of the resist 600 formed by pressing the mold.

As shown in FIG. 16B, the resist 600 is cured by ultraviolet rays while the mold of the stamp material 500 is pressed against the resist 600. The resist 600 may be cured by heat instead of ultraviolet light. Then, the mold of the stamp material 500 is removed from the resist 600. In this way, the cured resist 600 can be used as the incident region 210, the branching region 220, or the emission region 230.

In the present embodiment, an example has been described in which the first fill factor of the second grooves 222 or the second fill factor of the third grooves 232 is a value of 0.05 or more and 0.95 or less. Similar to the fill factor of the second grooves 222 and the third grooves 232, the fill factor of the first grooves 212 may be 0.05 or more and 0.95 or less.

In the present embodiment, an example has been described in which the thickness 248 of the resist film between the bottom surface of the second grooves 222 and the glass plate 112 is 10 nanometers or more and less than 500 nanometers. Similar to the thickness 248 of the resist film of the second grooves 222, the thickness of the resist film between the bottom surface of the first grooves 212 and the glass plate 112 may be 10 nanometers or more and less than 500 nanometers. Similarly, the thickness of the resist film between the bottom surface of the third grooves 232 and the glass plate 112 may be 10 nanometers or more and less than 500 nanometers.

The present disclosure is explained on the basis of the exemplary embodiments. The technical scope of the present disclosure is not limited to the scope explained in the above embodiments and it is possible to make various changes and modifications within the scope of the disclosure. Further, new exemplary embodiments generated by arbitrary combinations of them are included in the exemplary embodiments of the present disclosure.

What is claimed is:

1. A projection substrate for projecting an image onto a second surface that is opposite to a first surface, while transmitting at least a portion of light in a specific wavelength range incident from the first surface to the second surface, comprising:
a transparent glass plate that is provided on the first surface; and
a diffraction grating that i) is provided between the first surface and the second surface, positioned closer to the second surface than the glass plate and ii) has a plurality of grooves formed by a resist so that the light corresponding to the image propagates while being diffracted, wherein
a thickness of a resist film between a bottom surface of the grooves and the glass plate is determined on the basis of a wavelength of the light diffracted in the grooves.

2. The projection substrate according to claim 1, wherein
the thickness of the resist film between the bottom surface of the grooves and the glass plate is determined on the basis of a depth of the grooves and a pitch of the grooves.

3. The projection substrate according to claim 1, wherein
the thickness of the resist film is 10 nanometers or more and less than 500 nanometers.

4. The projection substrate according to claim 1, wherein
a difference between a refractive index of the resist and a refractive index of the glass plate is 0.4 or less.

5. The projection substrate according to claim 1, wherein
a fill factor of the diffraction grating is 0.05 or more and 0.95 or less.

6. The projection substrate according to claim 1, comprising:
a first diffraction grating that reflects the light incident from the first surface in a predetermined direction;
a second diffraction grating that diffracts a portion of the light incident from the first diffraction grating; and
a third diffraction grating that reflects at least a portion of the light incident from the second diffraction grating and projects the reflected light as image light; wherein
a thickness of the resist film between a bottom surface of the grooves of the second diffraction grating and the glass plate is determined on the basis of the wavelength of light diffracted in the grooves.

7. The projection substrate according to claim 1, comprising:
a plurality of glass plates; wherein
the plurality of glass plates are each formed with the diffraction grating for diffracting the light in a different wavelength range, and
a thickness of each of the resist films corresponding to the plurality of glass plates is determined on the basis of the wavelength of the light diffracted by the diffraction grating formed on each of the glass plates.

8. The projection substrate according to claim 7, wherein
the diffraction grating corresponding to the first wavelength range has a greater thickness of the resist film compared to the diffraction grating corresponding to a second wavelength range, which is shorter than the first wavelength range.

9. The projection substrate according to claim 1, wherein
the thickness of the resist film is 30 nanometers or more and less than 200 nanometers when a pitch of the grooves is 260 nanometers.

10. The projection substrate according to claim 1, wherein
the grooves include:
a plurality of first grooves that are arranged to guide, to a predetermined branching region, the light from an incident region that guides the light into the projection substrate; and
a second groove that is formed to be inclined, relative to a first direction, in a second direction at an angle that is half of a first angle that is formed by the first direction and the second direction, the first direction is being a direction from the incident region to the branching region and the second direction is being a direction from the branching region to a predetermined emission region; wherein
the emission region is configured to emit the light to a user's eye,
the branching region guides a portion of the light to the emission region, and
the thickness of the resist film is 20 times or less a depth of the second groove.

11. A method for manufacturing a projection substrate for projecting an image, comprising the steps of:
applying a resist on a transparent glass plate;
pressing a mold formed with a plurality of grooves against the resist to a position determined on the basis of a wavelength of light diffracted in the plurality of grooves;
curing the resist by ultraviolet rays or heat while the mold is pressed against the resist; and
removing the mold from the resist.
